(19) United States
(12) Patent Application Publication
(10) Pub. No.: US 2010/0287062 A1
(43) Pub. Date: Nov. 11, 2010

(54) Method and Apparatus for Facilitating Buyer Driven Transaction

(75) Inventors: Yufeng Liang, West Windsor, NJ (US); Neil FitzGerald, Rockville, MD (US); Chris Anderson, Ithaca, NY (US)

Correspondence Address: Kessler Law and Consulting PLLC, 59 Fox Den Road, Mount Kisco, NY, 10549, US

(73) Assignee: Price Whispers, Inc., Lewes, DE (US)

(21) Appl. No.: 12/615,225

(22) Filed: Nov. 9, 2009

Related U.S. Application Data
(60) Provisional application No. 61/113,232, filed on Nov. 11, 2008.

(51) Int. Cl. G06Q 30/00

(52) U.S. Cl. 705/26

(57) ABSTRACT

A method and apparatus for facilitating a buyer driven transaction are provided. The method comprises the steps of registering a seller to receive one or more conditional purchase offers, the seller agreeing to one or more terms to be employed upon entry into a transaction with a buyer upon acceptance of one of the one or more conditional purchase offers, and registering a buyer to submit one or more conditional purchase offers, the buyer agreeing to one or more terms to be employed upon entry into a transaction with the seller upon acceptance of one of the one or more conditional purchase offers. A conditional purchase offer is received from the buyer for a particular defined product, the conditional purchase offer including at least one or more product indicators, a price offer, and an offer expiration. The submitted conditional purchase offer is provided to the seller associated with the particular defined product. The seller is able to bind the buyer to purchase the particular defined product in accordance with the terms set forth in the conditional purchase offer and the agreed upon terms, and also to bind the seller to sell the particular defined product in accordance with the terms set forth in the conditional purchase offer and the agreed upon terms upon acceptance of the conditional purchase offer by the seller.

### CROSS REFERENCE TO RELATED APPLICATIONS

This application claims the benefit of U.S. Provisional Patent Application Ser. No. 61/113,232 titled METHOD AND APPARATUS FOR DEMAND COLLECTION, REPORTING, AND ORDER FULFILLMENT, filed Nov. 11, 2008 to Liang et al., the entire contents thereof being incorporated herein by reference.

### FIELD OF THE INVENTION

This application is related generally to the field facilitating transactions between buyers and sellers, and more particularly is directed to a transaction including a buyer-driven pricing scheme for purchasing a particular item from a particular seller.

### BACKGROUND OF THE INVENTION

In a modern retail setting, sellers of various products typically advertise a predetermined price for a product, and customers are required to pay the predetermined price for the product. If a buyer is not satisfied with the price for a product, he or she has two choices—either not to buy the product, or to wait passively for the seller to reduce the price (often at the end of an inventory cycle, holiday season, or other sale time, all of which may be inconvenient for the buyer). This situation may arise in both an in-person retail setting and an online setting.

A number of solutions have been proposed related to buyer-driven pricing, ranging from online auctions, reverse auctions and the like. A well known example, Priceline.com®'s “Name Your Own Price®” model (as described in U.S. Pat. Nos. 5,794,207 and 7,386,508, as well as other patents) allows buyers to submit their commitments to purchase a specified type or category of products (conditional purchase offers) to a centralized broker, who in turn makes those conditional purchase offers available to a set of sellers to bid on. This model assumes that buyers only care about the price of the product or service and do not care about the order fulfilling seller, or some other precise details about the transaction. In the case of an airline ticket or hotel, it assumes that the potential purchaser is flexible on location, time of flights and airline or hotel chain and the like. Such a reverse auction model may make the sellers anonymous and encourages price competition among sellers for non-distinguished goods within a product type. Ultimately, however, this type of auction is successful based upon different valuation of a product by various sellers, and perhaps the ability to substitute various products within the specified product type for a particular seller. Thus, the ability for a potential seller to substitute among various good and services aids in allowing this sales model to function well. There is a significantly reduced and/or eliminated benefit from this model, however, if the buyer wishes to have a particular product from a particular seller, and thus the PriceLine® offering does not allow a potential buyer to identify a particular product, but only a class of products, thus giving potential sellers flexibility in meeting the order demand.

Such a reverse auction model is advantageous in selling certain types of commodity products and services to highly price sensitive consumers where price is the dominant (or in some cases, the only) factor in the consumer's decision process. In many buying scenarios however, a buyer's purchase decision criteria may include many additional factors including but not limited to retailer brand, product brand, product quality, service level, shopping experience, and precise times and dates of services. These types of product and service purchases do not work within an anonymous selling process and additionally do not align with many sellers' market strategies around building and sustaining a meaningful brand positioning.

More traditional auction sites, such as Ebay® and others, allow a seller to list a particular item for sale, and even set a reserve price below which the seller will not part with the item. Potential buyers bid on the item for sale over a fixed time period. At the end of the time period, the bidder with the highest bid wins the item and is obligated to buy the item. Of course, this system generally only works for single, unique items. It may become cumbersome for a retailer with a full inventory of items in various styles and sizes. Ebay® does offer a Dutch auction system, where a seller may offer a number of identical items for sale. All buyers pay the lowest winning bid. Thus, if three items are offered, all buyers pay the third highest winning bid. While this does allow a seller to sell multiple identical items, the seller does not extract the highest price for the items as all but the lowest winning bidder were willing to pay more for the item. Furthermore, in any such auction system, a potential buyer must wait for a seller to place an item on auction, must bid, and must wait for the completion of the auction. In such a situation the potential buyer must forgo buying the item elsewhere because, until they are outbid, they have made a commitment to buy a product up to a particular price, if they win.

Accordingly, it would be advantageous to provide a method and apparatus for processing conditional purchase offers in non-anonymous retail environments that enable buyers to specify product, event and/or service details (e.g. seller, brand, location, size, color, delivery date, event date, ticket section, etc.) in addition to price and general product type information at any time without depending on sellers to put the product on sale.

### SUMMARY OF THE INVENTION

In accordance with the invention a method and apparatus for processing conditional purchase offers integrated within branded retail environments that are hosted and maintained by sellers is provided. Additionally, a method and apparatus is provided in accordance with the invention for allowing buyers to provide, and sellers to receive and consider, conditional purchase offers for goods and services that would normally otherwise be subject to a fixed retail price. Furthermore, a method and apparatus is provided in accordance with the invention for receiving product and other point of sale information from a seller, receiving conditional purchase orders from buyers relating to one or more of the product or other point of sale information, storing the information provided by the seller and the buyer, and allowing the seller to accept one or more conditional purchase offers, thus binding the buyer and seller.

In one preferred embodiment of the invention, a centralized server, known as a demand processing server is utilized to store the various information provided by buyers and sellers, and allow access to that information by those buyers and sellers to facilitate and complete one or more purchase transactions. A potential buyer may set up an account or the like on the demand processing server through the use of a buyer subscription user interface. The buyer subscription user interface preferably captures demographic information (e.g. birthdate/age, geographic region, etc.), payment information (e.g. credit card information, pay-pal accounts, etc.) and fulfillment details (e.g. shipping address, shipping defaults, etc.) from potential buyers. In addition, the buyer subscription interface preferably executes an agreement that binds the buyer to all accepted purchase offers and offers other terms governing any future transaction. In this manner, all details of the transaction from the buyer's side are taken care of and agreed upon in advance, leaving only the actual purchase transaction details to be determined between buyer and seller in the future. All captured buyer information may be stored on the demand processing server. Additionally, other methods for capturing information related to a potential buyer may be provided.

Similarly, a seller wishing to use the features of the invention in selling their goods or services may set up an account through a seller subscription user interface. Such a seller subscription interface may be provided to allow a potential seller to provide and store various sale related information. The seller subscription interface and subscription process preferably integrates the sellers product information to the SKU level of specificity into the service (e.g. through product list upload, web service provision, dynamic Javascript parsing of product web pages, etc.), captures billing information for the seller (e.g. billing address, billing contact, etc.) and executes an agreement that binds the seller to fulfill all accepted buyer purchase offers and define all other terms of any potential transaction with a buyer, including a potential payment to a service provider or other entity that may be hosting or otherwise providing services in accordance with this invention. In this manner, all details of the transaction from the seller's side are taken care of and agreed upon in advance, leaving only the actual purchase transaction details to be determined between buyer and seller in the future. All captured seller information may be stored on the demand processing server. Additionally, other methods for capturing information related to a potential seller may be provided.

After setting up buyer and seller information at the demand processing server, a potential buyer may use the system in order to present one or more conditional purchase offers to a seller for purchase of one or more goods or services. The buyer may preferably employ a demand collection user interface to present a conditional purchase offer to a seller in a number of potential scenarios. If the buyer is browsing a seller's online store, the buyer may present a conditional purchase offer for the seller's goods and service offerings to the seller. A conditional purchase offer submission mechanism may be preferably embedded in a seller's on-line store or website, or may be provided to the buyer via a widget or other client installed on the buyer's computer or internet access device. Such a submission mechanism may also be provided on a buyer's mobile phone or other mobile access device. If the buyer views an object in a seller's bricks and mortar sales location, on an advertisement, billboard, television or otherwise learns of the availability of a particular good or service in a situation where a direct link associated with the desired good or service is inconvenient, the buyer may present a conditional purchase offer to a seller via a client installed on the buyer's mobile phone or other mobile access device.

These demand collection user interfaces preferably enable the buyer to authenticate against a third party (or other locally hosted) server and specify a purchase offer that preferably includes a service or product identifier at the Stock Keeping Unit (SKU) level of specificity (e.g. a pair of brand specific black shoes, size 9 from a specified retailer), an offer price (or a discount level off of the service/product listing price), and an offer expiration date. Upon buyer submission, the purchase offer is preferably stored and processed at the demand processing server. Any conditional purchase offers stored on the server may preferably be modified and/or deleted by the originating potential buyer until the time of offer expiration or offer acceptance by the involved seller. Additional information that may be captured via the demand collection interface includes offer date and time, offer reason (e.g. competitive price, expensive list price, etc.), specified competitor, quantity, etc. The demand collection interfaces may also be integrated within a seller's environment to enable conditional offer specification on a group of products and/or services. A preferable example of this is the buyer using the demand collection interface to specify a conditional purchase offer on an entire pre-selected online shopping cart. The demand collection interface preferably facilitates this conditional purchase offer making process with the provision of decision support tools (e.g. integrated discount indicators on likelihood of offer acceptance, server-based reporting, email and mobile communications support, support of third party web sites providing analysis of offers, etc.) integrated therein.

A participating seller may also authenticate to the demand processing server and retrieve and review any buyer purchase offers involving their products through a demand review user interface. A seller is presented with the option of binding the buyers to contracts based on the terms presented by a buyer in the buyer's conditional purchase offer. If an offer is accepted, the server may preferably communicate these accepted offers to the associated buyers via email, mobile text or other medium and provide the buyer with the required information (e.g. web page link, discount code, phone number, etc.) to complete the transaction at the offered discount with the seller. The seller preferably retrieves the buyer related payment information from the demand processing server, processes the payment, and fulfills the order. Alternatively, the server may facilitate the secure collection of any outstanding information items required to complete the transaction via emails, the buyer interface to the server, mobile texts, etc. Payment processing is preferably processed with the seller's own systems including but not limited to their e-commerce system or their customer service representatives. A seller may determine whether to accept an offer (conditional purchase offer) based upon various factors such as the offer price, their selling strategy and the availability of the product or service. The demand review user interface preferably facilitates this decision making process with the provision of decision support tools (e.g. reporting, analytics, decision-support algorithms, geographic source of offers, what-if analysis, etc.) integrated therein.

Using the demand review user interface, a seller may present counter-offers to buyers that have previously provided conditional purchase offers. By selecting one or more of the existing conditional purchase offers, rather than providing an outright rejection thereof, a seller may specify a counter-offer, preferably including a discount percentage, offer expiry date, and any other information that may be different from terms provided in the initially presented conditional purchase offer. Upon seller submission, the counter offer is preferably stored and processed at the demand processing server and may be grouped by offer group or date for future reporting, analysis and decision support. The server preferably communicates these counter-offers to the associated buyers via email, mobile text or other medium and provide the buyer with the required information (e.g. web page link, discount code, phone number, etc.) to complete the transaction at the offered discount with the seller. If a counter offer is accepted by a buyer, both the buyer and seller are at that point bound to the transaction. Thereafter, the seller preferably retrieves the buyer related payment information from the demand processing server, processes the payment, and fulfills the order in a manner similarly to when an initially presented conditional purchase offer is accepted by the seller. Alternatively, the server may facilitate the secure collection of any outstanding information items required to complete the transaction via emails, the buyer interface to the server, mobile texts, etc. Payment processing is preferably processed with the seller's own systems including but not limited to their e-commerce system or their customer service representatives. A seller may determine whether to counter-offer on a buyer presented conditional purchase offer based upon various factors such as the offer price and the availability of the product or service. The demand review user interface preferably facilitates this decision making process with the provision of decision support tools (e.g. reporting, analytics, decision-support algorithms, what-if analysis, etc.) integrated therein.

After authenticating to the demand processing (or other) server, a participating seller may specify any number of processing rules to automate the processing of buyer conditional purchase offers. Using a rules management user interface, the seller may specify an action for the server to take on all conditional purchase offers received for their products or services, or any subset thereof. Examples of these actions include Accept, Decline or Counter-Offer, request more information, propose missing terms, and the like. The seller may additionally specify relevant product or service categories or sub-categories to which a particular rule should apply, and may also designate a relevant discount range for processing. An exemplary sample rule that may be configured by the seller may be “Accept all bids in the Shoes category with a requested discount of 10% or less”. Another exemplary sample rule that may be set up by the seller may be “Counter-offer with a 10% discount on all bids in the Shoes category with requested discounts greater than 10%”. The rules management user interface provided in accordance with the invention preferably facilitates the rules creation and management making process with the provision of decision support tools (e.g. reporting, analytics, decision-support algorithms, what-if analysis, etc.) integrated therein.

Still other objects and advantages of the invention will in part be obvious and will in part be apparent from the specification and drawings.

The invention accordingly comprises the several steps and the relation of one or more of such steps with respect to each of the others, and the apparatus embodying features of construction, combinations of elements and arrangement of parts that are adapted to affect such steps, all as exemplified in the following detailed disclosure, and the scope of the invention will be indicated in the claims.

### BRIEF DESCRIPTION OF THE DRAWINGS

For a more complete understanding of the invention, reference is made to the following description and accompanying drawings, in which:

FIG. 1 is a graphical representation of a preferred relationship between various elements in accordance with the invention;

FIG. 2 is a schematic illustration of a demand processing server in accordance with an embodiment of the present invention;

FIG. 3 is a flowchart diagram depicting a seller subscribing to a service in accordance with an embodiment of the invention;

FIG. 4 is a flowchart diagram depicting a buyer subscribing to a service in accordance with an embodiment of the invention;

FIG. 5 is a flowchart diagram depicting a buyer submitting a conditional purchase order from a seller e-commerce website in accordance with an embodiment of the invention;

FIG. 6 is a flowchart diagram depicting a buyer submitting a conditional purchase order via a mobile device in accordance with an embodiment of the invention; and

FIG. 7 is a flowchart diagram depicting a seller evaluating a conditional purchase order in accordance with an embodiment of the invention.

### DETAILED DESCRIPTION OF THE PREFERRED EMBODIMENTS

The invention will now be described, making reference to the following figures in which like reference numbers refer to like elements.

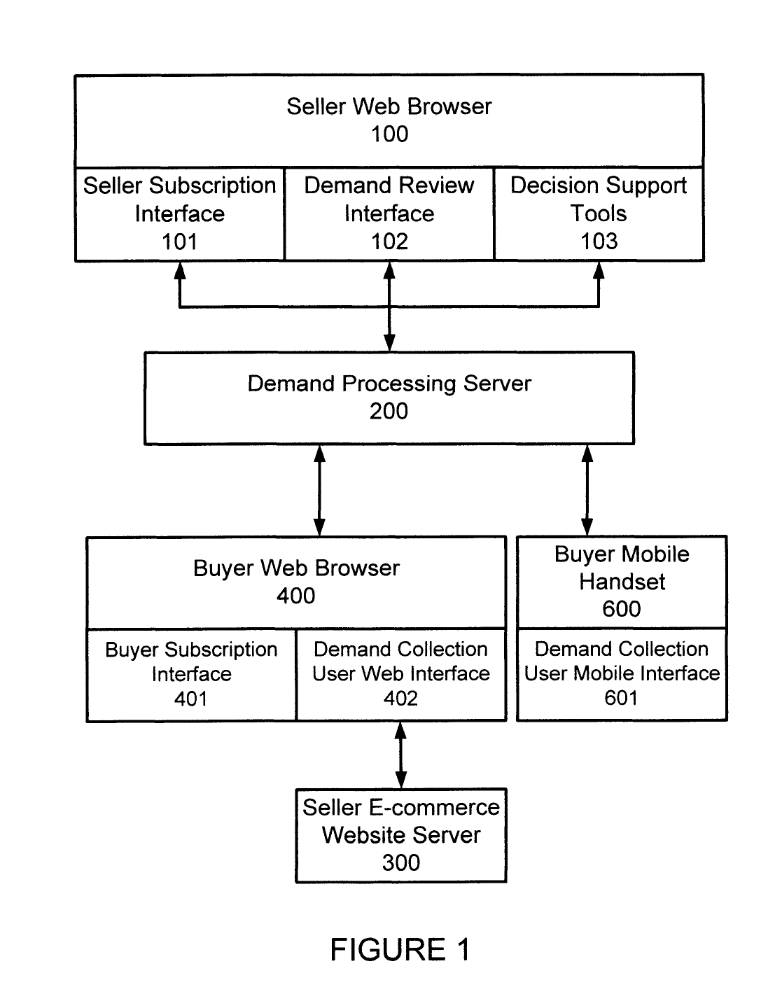

Referring first to FIG. 1, a first embodiment in accordance with the invention is shown. As is shown in FIG. 1, the present invention includes a demand processing server 200 that is in communication with one or more of a seller web browser 100, a buyer web browser 400, and a buyer mobile handset 600. A seller e-commerce website server 300 may also be provided in communication with buyer web browser 400.

Demand processing server 200 may comprise a cluster of computer servers, or other appropriate computing and storage apparatus, which host web applications and database applications. Demand processing server 200 is adapted to generate web pages that can be accessed via the World Wide Web or other available private network and allows buyers and sellers to conduct a variety of tasks. Demand processing server 200 may be operated by a third party provider, a seller or other individual retail organization, or a buying entity, such as a high volume buyer, buying club, or the like. Demand processing server 200 acts as a processing server, allowing potential buyers and sellers to otherwise employ the features of the invention.

A seller may access demand processing server 200 via a seller web browser session 100. Such access may be used for initial subscription implementation, review of stored information regarding conditional purchase offers, and use of various decision tools adapted to aid a seller in determining whether to accept, reject or counter offer one or more particular conditional purchase offers. When first accessing demand processing server, a seller a seller subscription interface 101 via seller web browser 100. Seller subscription interface 101 and subscription process preferably integrates the sellers product information to the SKU level of specificity into the service (e.g. through product list upload, web service provision, etc.), captures billing information for the seller (e.g. billing address, billing contact, etc.) and executes an agreement that binds the seller to fulfill all accepted buyer purchase offers and define all other terms of any potential transaction with a buyer, including a potential payment to a service provider or other entity that may be hosting or otherwise providing services in accordance with this invention. In this manner, all details of the transaction from the seller's side are taken care of and agreed upon in advance, leaving only the actual purchase transaction details to be determined between buyer and seller in the future.

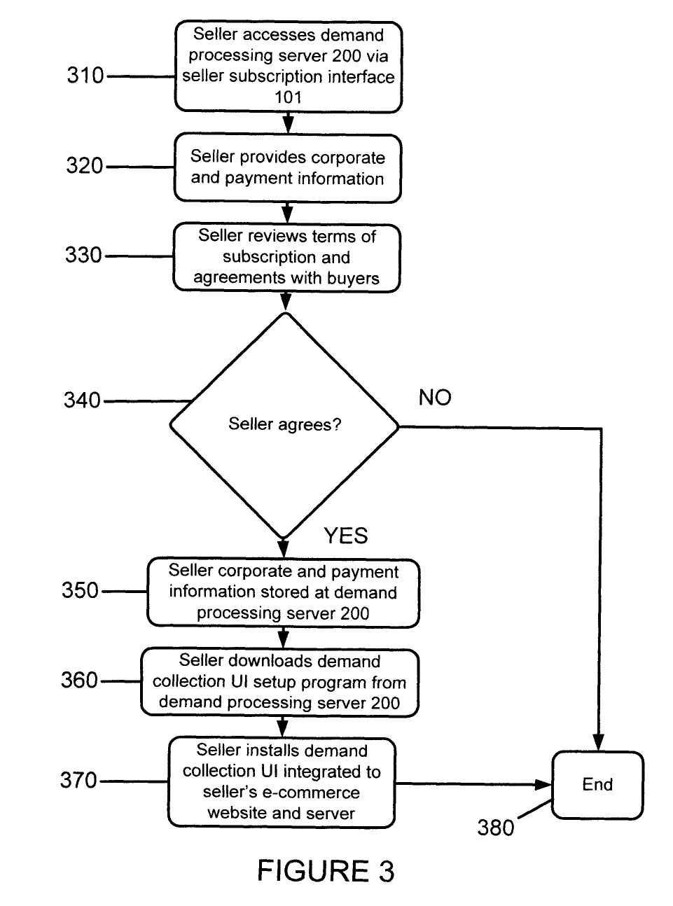

Referring next to FIG. 3, a seller subscription process will be described. At step 310 of FIG. 3 the seller first accesses demand processing server 200 via seller subscription interface 101. Processing then passes to step 320 where the seller provides various corporate and payment information so that the seller is able to be identified by demand processing server 200 in the future, and so that the seller's information is properly stored. Thereafter, the seller reviews the various terms of subscription, and also reviews the terms of agreements that will be used during any transactions with buyers at step 330. The seller must agree to the terms and agree to be bound by the provided agreements at step 340, or processing ends at step 380. It may be possible to provide a number of agreements from which a seller may choose, or a seller may provide their own agreements to be user in any purchase transactions. Once the seller agrees to the terms at step 340, processing passes to step 350 where the seller corporate and payment information are stored to demand processing server 200. After such storage, the seller has been registered with demand processing server 200 and is ready to employ the system. Processing then proceeds to step 360 and 370 where the seller downloads and installs a demand collection UI that is integrated into the seller's e-commerce website and server. Thus, potential buyers will have access to the system from the seller's e-commerce website. Processing then ends at step 380.

Once this processing as described making reference to FIG. 3 is completed, the seller is then provided access to a demand review interface 102 and a set of decision support tools 103 stored at demand processing server 200, accessed via seller web browser session 100. The use of these features will be described below.

Referring back to FIG. 1, a buyer may accesses central server 200 via a web browser session 400 and activate a buyer subscription user interface 401. Such activation may allow a potential buyer to set up an account or the like on demand processing server 200. The buyer subscription user interface preferably captures payment information (e.g. credit card information, paypal accounts, etc.) and fulfillment details (e.g. shipping address, shipping defaults, etc.) from potential buyers. In addition, the buyer subscription interface preferably executes an agreement that binds the buyer to all accepted purchase offers and offers other terms governing any future transaction. In this manner, all details of the transaction from the buyer's side are taken care of and agreed upon in advance, leaving only the actual purchase transaction details to be determined between buyer and seller in the future. This information is in turn forwarded to demand processing server 200, which validates and saves the information into a database to be used in future transactions associated with this particular potential buyer.

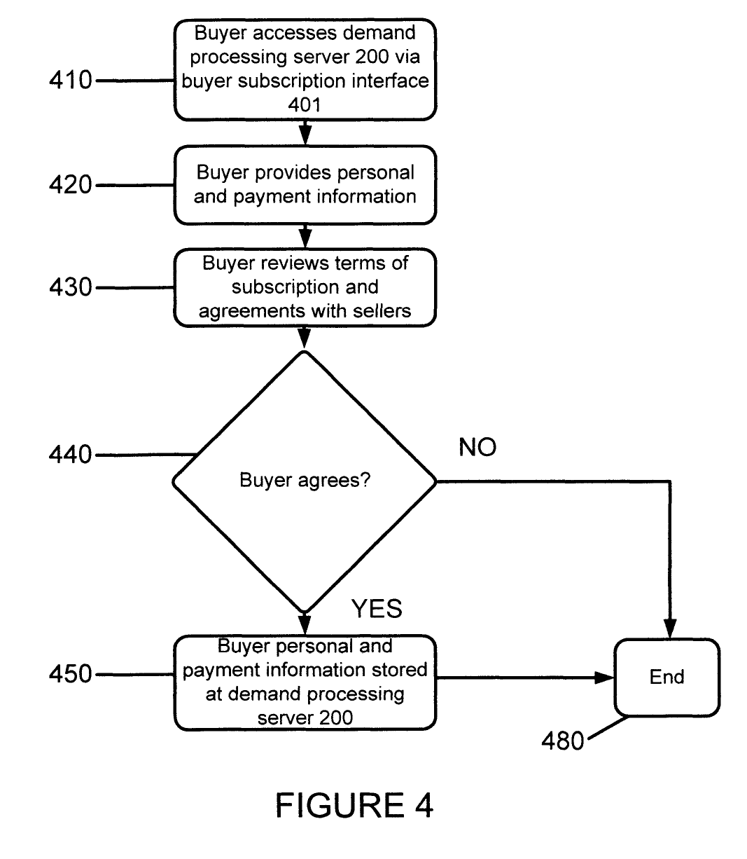

Referring next to FIG. 4, a buyer subscription process will be described. At step 410 of FIG. 4 the seller first accesses demand processing server 200 via buyer subscription interface 401. Processing then passes to step 420 where the buyer provides various personal and payment information so that the buyer is able to be identified by demand processing server 200 in the future, and so that the buyer's information is properly stored. Thereafter, the buyer reviews the various terms of subscription, and also reviews the terms of agreements that will be used during any transactions with sellers at step 430. The buyer must agree to the terms and agree to be bound by the provided agreements at step 440, or processing ends at step 480. It may be possible to provide a number of agreements from which a buyer may choose, or a buyer may provide their own agreements to be user in any purchase transactions. Once the buyer agrees to the terms at step 440, processing passes to step 450 where the buyer personal and payment information are stored to demand processing server 200. After such storage, the seller has been registered with demand processing server 200 and is ready to employ the system. Processing then ends at step 480.

Referring once again to FIG. 1, once registered with demand processing server 200, a buyer may access demand processing server 200 via a demand collection user web interface 402, via buyer web browser 400. Typically such access will be performed in accordance with access via a seller e-commerce website and server 300, but such a relationship need not be present. In such an embodiment of the invention, a buyer accesses seller e-commerce website server 300 and browses the website to find a good or service the buyer wishes to purchase. The buyer may then decide to pay the listed price for the good or service, or decide to specify a conditional purchase offer (e.g. offer price other than list or current price and offer expiry date) on a selected item or designated group of items. The buyer selects an activation button on the seller website and submits the conditional purchase offer to demand processing server 200 via demand collection user web interface 402.

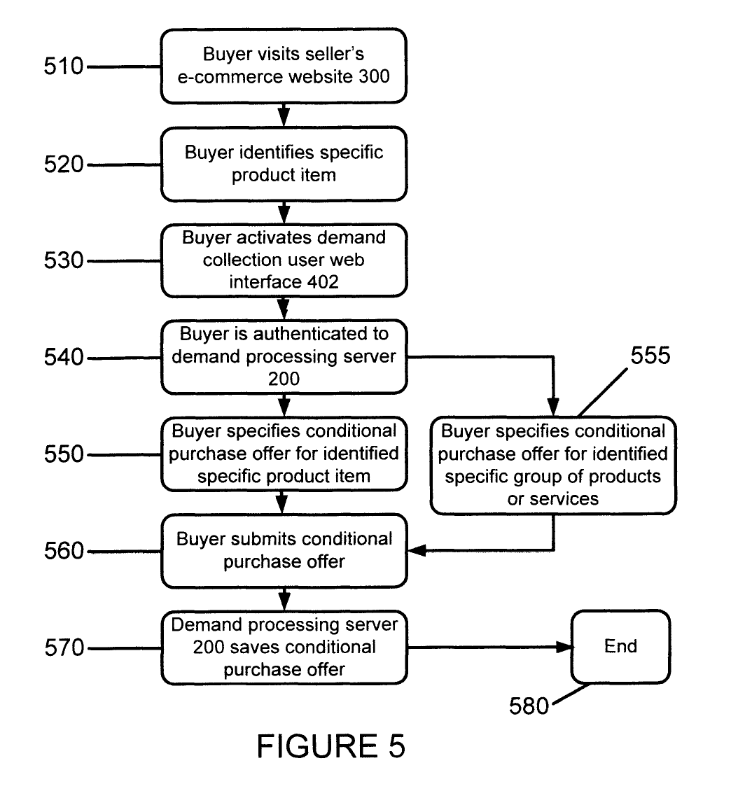

Referring next to FIG. 5, the demand collecting process employing a web browser and seller e-commerce website will be described. Processing begins at step 510 with a buyer visits a seller's e-commerce website 300. While browsing, the buyer identifies a specific product item he or she would like to purchase at step 520. At step 530 the buyer activates demand collection user web interface 402 by selecting an indicator on the seller's e-commerce website. Upon such activation the user is authenticated at step 540 to demand processing server 200 via buyer web browser 400, demand processing server 200 querying or otherwise recognizing the buyer (such as through the use of a cookie or the like) and associating this authenticated buyer with buyer information entered during the buyer subscription process described above. Selection of the indicator to activate the demand collection user web interface 402 may automatically associate with a viewed product, or the buyer may have to enter various product information, such as SKU number, size, color, etc. Once authenticated, the buyer may specify a conditional purchase offer for the identified specific product item at step 550 preferably including one or more of a specified product, discount level or price to be offered for commitment to purchase, and an expiration date of the conditional purchase offer, and at step 560 this conditional purchase offer is submitted. This conditional purchase offer may also allow for a buyer to indicate a time and date of an offer, a reason why they believe the conditional purchase offer should be accepted (e.g a competitive price reference, citing of an expensive list price, etc.). Alternatively, the demand collection user web interface 402 may allow, at step 555, a buyer to submit a conditional purchase offer on a predetermined set of goods and/or services, such as a set of goods provided in an entire online shopping cart, and as noted above at step 560 this conditional purchase offer is submitted. Preferably, the demand collection user web interface 402 facilitates the submission of either type of conditional purchase offer, providing a group of buyer decision support tools. These tools may include integrated discount indicators on likelihood of offer acceptance, server-based reporting, email and mobile communications support, support of third party web sites providing analysis of offers, etc. The conditional purchase offer is then saved at demand processing server 200 for later processing at step 570 and processing ends at step 580.

Referring once again to FIG. 1, a buyer visiting a brick and mortar store may wish to submit a conditional purchase order for an item or group of items viewed at the store. A submission mechanism for submitting this conditional purchase offer may be provided on a buyer's mobile phone or other mobile access device. Thus, if the buyer views an object in a seller's brick and mortar sales location, on an advertisement, billboard, television, or otherwise learns of the availability of a particular good or service in a situation where a direct link associated with the desired good or service is inconvenient, the buyer may present a conditional purchase offer to a seller via a client installed on the buyer's mobile phone or other mobile access device. Such a buyer shopping in a seller's physical store can employ a demand collection user mobile interface 601 on the buyer's mobile handset 600, which interacts with demand processing server 200. The buyer is thus able to browse the seller's store and decide to specify a purchase offer (e.g. product specific tag number, offer price other than list or current price and offer expiry date) on a selected item. The buyer inputs the purchase offer in the Demand Collection User Interface and submits the offer to demand processing server 200.

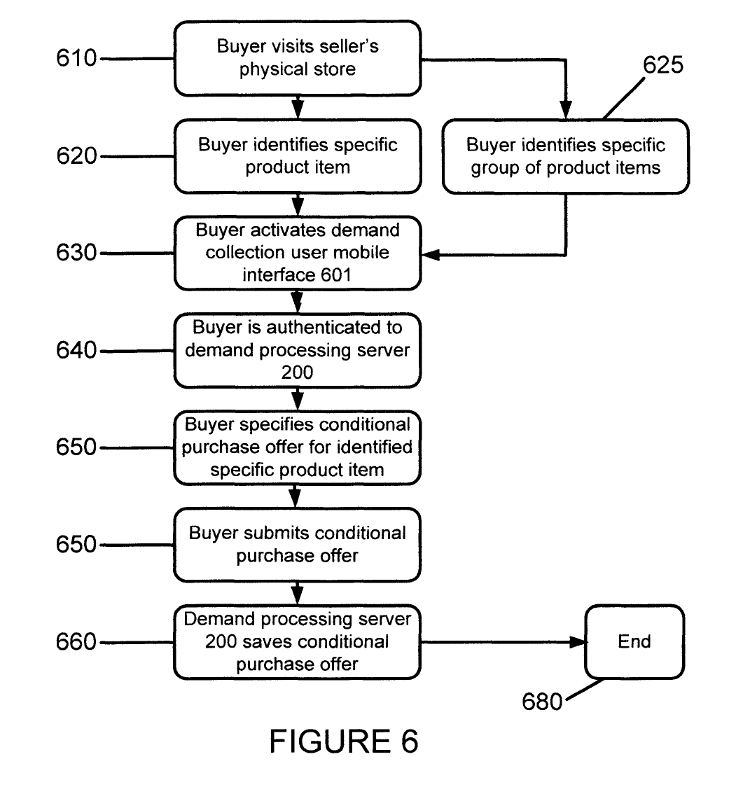

Referring next to FIG. 6, the demand collecting process employing a buyer's mobile handset or other entry device will be described. Processing begins at step 610 with a buyer visits a seller's store. While a store is described, it is contemplated that a buyer may learn of such a good or product from an advertisement, billboard, television, or otherwise learn of the availability of a particular good or service in a situation where a direct link associated with the desired good or service is inconvenient. While visiting the buyer's store, the buyer identifies a specific product item he or she would like to purchase at step 620, or identifies a group of items he or she would like to purchase at step 625. At step 630 the buyer activates demand collection user mobile interface 602 on their mobile handset 600. Upon such activation the user is authenticated at step 640 to demand processing server 200, demand processing server 200 querying or otherwise recognizing the buyer (such as through the use of a cookie or the like) and associating this authenticated buyer with buyer information entered during the buyer subscription process described above. Once authenticated, the buyer may specify a conditional purchase offer for the identified specific product item or group of product items at step 650 preferably including one or more of a specified product, discount level or price to be offered for commitment to purchase, and an expiration date of the conditional purchase offer, or any other information that may be appropriate, such as offer date and time, offer reason, including indicating a competitive price, an expensive list price or the like. The buyer may enter various product information for each of the items, such as SKU number, size, color, etc., or may employ one or more known scanning technologies to automatically capture such information from a store or manufacturer label or hand tag or the like. At step 660 this conditional purchase offer is submitted. The conditional purchase offer is then saved at demand processing server 200 for later processing at step 670 and processing ends at step 680.

Referring once again back to FIG. 1, once a conditional purchase offer has been submitted to demand processing server 200, a seller may employ a demand review interface 102 to review these conditional purchase orders, and a set of decision support tools 103 to aid in a decision of whether the seller should accept the conditional purchase offer. Thus, when desired, a seller authenticates into demand processing server 200 via demand review interface 102 and reviews outstanding purchase offers on their products. These conditional purchase offers are associated with a particular seller based upon information entered during the seller subscription registration discussed above. With or without the user of decision support tools 103, the seller can determine whether to accept, reject or counter one or more of the stored conditional purchase offers. The seller is thus presented with the option of binding the buyers to contracts based on the terms presented by a buyer in the buyer's conditional purchase offer. If an offer is accepted, the seller retrieves the buyer related payment information from demand processing server 200, processes the payment, and fulfills the order. A seller may determine whether to accept an offer (conditional purchase offer) based upon various factors such as the offer price and the availability of the product. While sellers can accept, reject, counter or ignore outstanding purchase offers, they are bound to fulfill those purchase offers that they accept. Decision support tools 103 preferably facilitate this decision making process with the provision of decision support tools (e.g. reporting, analytics, what-if analysis) integrated therein.

As it is anticipated that a particular seller may receive a large number of conditional purchase offers for individual or groups of goods or services, a participating seller may specify any number of processing rules to automate the processing of buyer conditional purchase offers, preferably through the use of a rules management user interface as part of demand review interface 102, the seller may specify an action for the system to automatically implement, either to determine particular groups of conditional purchase offers to act upon, such as perhaps rejecting all conditional purchase offers that request greater than an 80% discount, for example, or to issue particular counter offers or other comments as will be described below. Such rules may be applied to all conditional purchase offers received for a particular seller's products or services, or any subset thereof. These actions may further include Accept, Decline or Counter-Offer, request more information, propose missing terms, and the like. The seller may additionally specify relevant product or service categories or sub-categories to which a particular rule should apply, and may also designate a relevant discount range for processing. The rules management user interface provided in accordance with the invention preferably facilitates the rules creation and management making process with the provision of decision support tools (e.g. reporting, analytics, decision-support algorithms, what-if analysis, etc.) integrated therein.

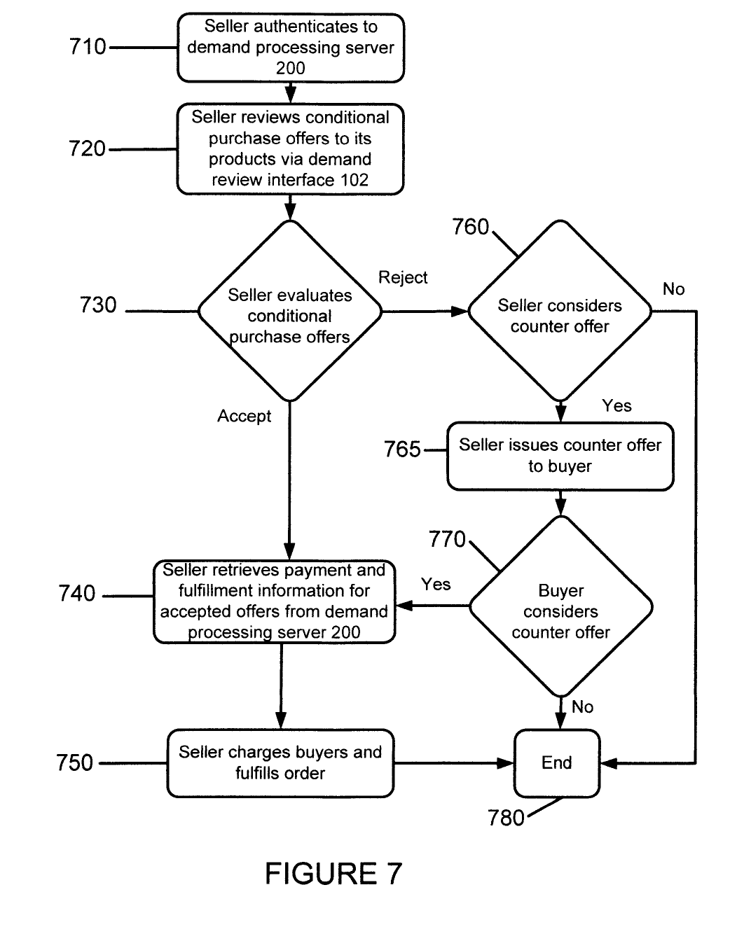

Referring next to FIG. 7, the demand reporting and order fulfillment process in accordance with the invention will be described. At step 710 a seller authenticates to demand processing server 200 via seller web browser 100 or other network infrastructure. Such authentication pairs the seller with seller subscription information entered as described above. At step 720 the seller reviews any conditional purchase offers to its products or services, or groups of products or services. Such a review is performed in accordance with the demand review interface 102, and may employ any of the processing rules that the seller may have imposed on their conditional purchase offers. Additionally, even if such rules are not automatically incorporated into the review process, a user may employ stored rules to facilitate reviews of the conditional purchase offers. By way of example, the seller may first wish to see all conditional purchase offers with less than a 10% discount as the seller may be most likely to accept these offers. Then proceeding to 20%, 30% etc. the seller can manage inventory and accept offers that make the most sense. Any number of such rules may be employed by the seller to separate conditional purchase orders into desirable batches to be reviewed by the seller. At step 730 the seller evaluates the conditional purchase offers. Such evaluation may employ decision support tools 103 and decision rules as noted above, but whether the tool are used or not, the decision to accept or reject a particular conditional purchase offer may be based at least in part upon various variables such as supply level, demand, cost, profitability targets, spoilage, and the like for the particular good or service. After evaluation, if the buyer determines to accept a particular conditional purchase offer, processing passes to step 740 where the seller retrieves payment and fulfillment information for accepted purchase orders from demand processing server 200, and at step 750 charges the buyers and fulfills the order. If any additional information is necessary from the buyer to complete the transaction, the buyer may be notified by electronic communication, message through one of the buyer interfaces or the like. A buyer may be notified of such an acceptance and need for any additional information by the system or seller directly. The buyer may be further provided with website links to the products, invoices or the like.

If at step 730 the seller decides to reject a particular conditional purchase offer, processing passes to step 760 where the seller then considers whether to issue a counter offer to the submitted conditional purchase offer, and may utilize the tools originally employed to determine whether to accept a particular conditional purchase offer, or other appropriate tools. If no counter offer is to be issued, processing passes to step 780 and ends. If however, the seller determines at step that it wishes to issue a counter offer, then rather than providing an outright rejection of a particular conditional purchase offer, at step 765 a seller may specify a counter-offer, preferably including a discount percentage, offer expiry date, and any other information that may be different from terms provided in the initially presented conditional purchase offer. Upon seller submission, the counter offer is preferably stored and processed at the demand processing server 200, and is provided to the conditional purchase offer submitting buyer either through one of the various web interfaces to demand processing server, or via email, other electronic communication, or other communication method and provides the buyer with the required information (e.g. web page link, discount code, phone number, etc.) to evaluate the counter offer. If the buyer rejects the counter offer, processing passes to step 780 and ends. If the buyer wishes to counter again, the processing may allow for yet another counter offer to be submitted, or alternatively, the buyer may be required to submit another conditional purchase offer, perhaps reference the originally submitted purchase offer and counter offer. If the buyer accepts the counter offer, then processing passes to step 740 and is processed as noted above,

As noted above, upon accepting a particular purchase offer or counter offer, the seller is then bound to provide the good or service in accordance with the agreements agreed upon during the seller and buyer subscription processes. Furthermore, in a particular embodiment of the invention, the seller may reject a conditional purchase offer, but make a counter offer. In such a situation, all other terms and conditions of the buyer's original conditional purchase offer may remain in place, and only the price may be changed. Alternatively, perhaps a substitute good might be offered (such as a different color) as the modification of the conditional purchase offer. It is contemplated that upon making such a counter offer, that upon acceptance by a buyer, the seller will be bound to provide the good or service in accordance with the counter offer.

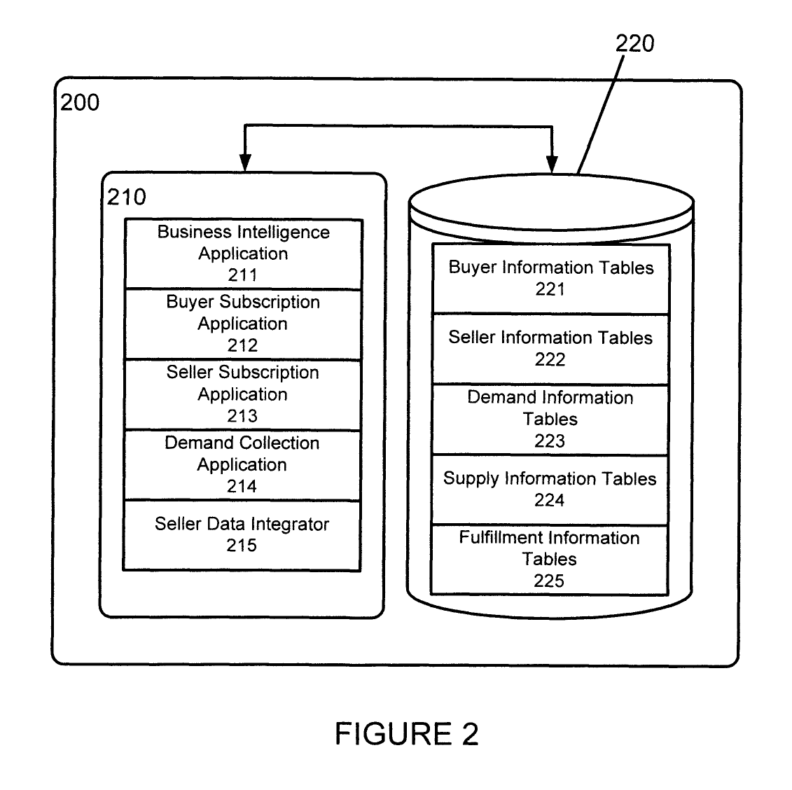

A schematic illustration of demand processing server 200 is shown in FIG. 2. As is shown in FIG. 2, demand processing server 200 comprises a central application server 210 and a central database 220. Central application server 210 and central database 220 may be hosted on a single server, may be distributed across a cluster of server, or may be hosted on remotely located servers.

Central application server 210 is adapted to process and implement a number of preferably provided software applications that perform the various functions as described above in accordance with the invention. A business intelligence application 211 is provided that may be accessed by a seller to run the demand review reports, decision support tools and order fulfillment reports via seller web browser 100, and demand review interface 102 and decision support tools 103. Thus, business intelligence application 211 provides various information and tools to sellers to determine outstanding conditional purchase orders, and various tools to assist a seller in determining whether they may wish to accept or reject such an outstanding conditional purchase offer.

A buyer subscription application is provided that is accessed by buyers via buyer subscription interface 401 and buyer web browser 400 to perform the buyer subscription method as described above that allow the buyer to subscribe to the various services in accordance with the invention. A seller subscription application 213 is provided that is accessed by sellers via seller subscription interface 101 and seller web browser 100 that allow sellers to subscribe to the various seller oriented services as noted above. A demand collection application 214 is provided that is accessed by a buyer via the demand collection user web interface 402 and buyer web browser 400, or via demand collection user mobile interface 601 and buyer mobile handset 600. The demand collection application 214 allows a buyer to input and submit conditional purchase offers to be stored on demand processing server 200, and reviewed by a seller associated with the goods subject to each of the conditional purchase offer. Finally a seller data integrator 215 is provided that loads supply data from the Seller databases into a supply information table 224 in the Central Database for decision support purposes, as will be described.

Central database 220 stores data at demand processing server 200 as received from a buyer or seller. The major sets of tables hosted in central database include buyer information tables 221 which store buyer profile, payment, shipment, and site access information, much of which is entered by the buyer during the buyer subscription process. Seller information tables 222 are provided to store seller profile, security, and service level information provided primarily during the seller subscription process. Demand information tables 224 are provided to store any conditional purchase offers submitted by buyers, and are accessible by the sellers when employing the demand review interface 102. Supply information tables 224 store the supply levels of the seller for various goods for sale on which the seller might receive one or more conditional purchase orders. These tables also store seller proprietary information and are populated by the seller data integrator 215 (from the seller databases) on a regular batch basis, or whenever else is considered appropriate. Finally, fulfillment information tables are provided to store statistical and other data about order fulfillment.

Therefore, as described in accordance with the application, a method and apparatus are provided to allow a seller to place goods or services for sale, and to receive one or more conditional purchase offers from one or more buyers. By accepting a conditional purchase offer, the seller is able to bind the buyer to purchase the item in accordance with the terms in the conditional purchase offer, and also bind itself to fulfill the requirements of the conditional purchase order from the seller side. A buyer may submit a conditional purchase order for a good or service available online or in a more traditional retail or advertising situation. By submitting such a conditional purchase offer, the user may receive the goods at a reduced price, but is bound to purchase the goods when accepted by a particular seller.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed:

1. A method for facilitating a buyer driven transaction, comprising the steps of:
receiving a conditional purchase offer from a buyer for a particular defined product, the conditional purchase offer including at least one or more product indicators, a price offer, and an offer expiration;
providing the conditional purchase offer to a seller associated with the particular defined product; and
binding the buyer to purchase the particular defined product in accordance with the terms set forth in the conditional purchase offer upon acceptance of the conditional purchase offer by the seller.

2. The method of claim 1, further comprising the steps of:
pre-registering the seller to agree to one or more terms and conditions to be employed upon acceptance of the conditional purchase offer; and
pre-registering the buyer to agree to one or more terms and conditions to be employed upon acceptance of the conditional purchase offer.

3. The method of claim 1, further comprising the step of providing a plurality of purchase offers to a seller, wherein the seller may determine whether to accept one or more of the plurality of purchase offers.

4. The method of claim 3, further comprising the step of providing decision support tools to the seller to aid in determining whether not accept a particular purchase offer.

5. The method of claim 1, wherein the conditional purchase offer is submitted by a buyer via a demand collection interface activated by a link provided on a seller's e-commerce website.

6. The method of claim 1, wherein the conditional purchase offer is submitted by a buyer via a mobile device.

7. The method of claim 6, wherein the conditional purchase offer is submitted for a product viewed by the buyer at a retail location.

8. The method of claim 6, wherein the conditional purchase offer is submitted for a product viewed by the buyer from an advertisement.

9. The method of claim 1 wherein the particular defined product comprises a group of particular products.

10. A method for facilitating a buyer driven transaction, comprising the steps of:
registering a seller to receive one or more conditional purchase offers, the seller agreeing to one or more terms to be employed upon entry into a transaction with a buyer upon acceptance of one of the one or more conditional purchase offers;
registering a buyer to submit one or more conditional purchase offers, the buyer agreeing to one or more terms to be employed upon entry into a transaction with the seller upon acceptance of one of the one or more conditional purchase offers;
receiving a conditional purchase offer from the buyer for a particular defined group of one or more products, the conditional purchase offer including at least one or more product indicators, a price offer, and an offer expiration;
providing the conditional purchase offer to the seller associated with the particular defined group of one or more products;
binding the buyer to purchase the particular defined group of one or more products in accordance with the terms set forth in the conditional purchase offer and the agreed upon terms upon acceptance of the conditional purchase offer by the seller; and
binding the seller to sell the particular defined product in accordance with the terms set forth in the conditional purchase offer and the agreed upon terms upon acceptance of the conditional purchase offer by the seller.

11. The method of claim 10, wherein the step of registering the seller further comprises the steps of:
uploading product information for one or more products to a centralized database;
providing a link from the sellers e-commerce website to initiate the submission of a conditional purchase offer by the buyer; and
associating a received conditional purchase offer with a particular of the one or more products at the centralized database.

12. The method of claim 10, wherein the step of registering the buyer further comprises the step of providing a conditional purchase order submission client on a mobile device thereof.

13. The method of claim 12, wherein the product indicator includes a scan of a product associated identifier.

14. The method of claim 10, wherein the product indicator comprises a SKU number.

15. The method of claim 10, wherein the step of registering the buyer further comprises the step of receiving payment and other fulfillment information to enable a seller to complete a transaction without further input from the buyer upon acceptance of the conditional purchase offer.

16. The method of claim 10 further comprising the step of submitting a counter offer by the seller proposing at least one term different from that of the purchase offer submitted by the buyer;
binding the buyer to purchase the particular defined group of one or more products in accordance with the terms set forth in the counter offer and the agreed upon terms upon acceptance of the counter offer by the seller; and
binding the seller to sell the particular defined product in accordance with the terms set forth in the counter offer and the agreed upon terms upon acceptance of the counter offer by the buyer.

17. The method of claim 10, further comprising the step of defining one or more rules by a seller for processing the conditional purchase offer.

18. The method of claim 17, wherein the rules automatically categorize the conditional purchase offer according to one or more attribute thereof.

19. The method of claim 18, wherein the one or more attribute comprises a one or more selected from the group of: a requested percentage discount, a product category, a product detail attribute, or an offer expiration date

20. A transaction apparatus for facilitating a buyer driven transaction, comprising:
a demand processing server and storage apparatus for receiving subscription information from a seller, for receiving seller subscription information from one or more buyers, for receiving one or more conditional purchase offers from the one or more buyers, for providing access to the one or more conditional purchase offers by the seller, for receiving an indication of acceptance or rejection of one or more of the conditional purchase offers, for providing one or more counter offers from the seller upon indication of rejection of one or more of the conditional purchase offers, for initiating payment to the seller in accordance with the acceptance of one or more of the conditional purchase offers, for initiating payment to the seller in accordance with the acceptance of one or more of the counter offers by the buyer, and for initiating order fulfillment to the buyer in accordance with the acceptance of the one or more conditional purchase offers or counter offers;
a seller web interface for accessing the demand processing server by a seller, the seller web interface allowing the seller to provide buyer subscription information, to review submitted conditional purchase offers, to utilize one or more analysis tools to determine whether to accept a submitted conditional purchase offer, to offer a counter offer to a submitted purchase offer, and to indicate acceptance of a submitted conditional purchase offer; and
a buyer web interface for accessing the demand processing server by a buyer, the buyer web interface allowing the buyer to provide subscription information, to submit one or more conditional purchase offers for one or more particular products, and to consider counter offers for one or more particular products.

21. The apparatus of claim 20, further comprising a buyer mobile interface for accessing the demand processing server by a buyer, the buyer mobile interface allowing the buyer to submit one or more conditional purchase offers for one or more particular products.

22. The apparatus of claim 21, wherein the one or more particular products are located at a retail location.

23. The apparatus of claim 20, wherein:
the seller subscription information includes one or more terms to be employed upon entry into a transaction with a buyer upon acceptance of one of the one or more conditional purchase offers; and
the buyer subscription information includes agreement to one or more terms to be employed upon entry into a transaction with the seller upon acceptance of one of the one or more conditional purchase offers, and payment and other fulfillment information to enable a seller to complete a transaction without further input from the buyer upon acceptance of the conditional purchase offer.

24. The apparatus of claim 20, wherein:
the seller subscription information includes one or more terms to be employed upon entry into a transaction with a buyer upon acceptance of one of the one or more counter offers; and
the buyer subscription information includes agreement to one or more terms to be employed upon entry into a transaction with the seller upon acceptance of one of the one or more counter offers, and payment and other fulfillment information to enable a seller to complete a transaction without further input from the buyer upon acceptance of the counter offer.

25. The apparatus of claim 24, wherein the seller subscription information includes product information for each individual product for which the seller will accept a conditional purchase offer from a buyer.

26. The apparatus of claim 20, wherein the buyer web interface is provided at a seller's e-commerce website associated with one or more products for which the seller will accept a conditional purchase offer.
